(19) United States
(12) Patent Application Publication
(10) Pub. No.: US 2025/0045453 A1
(43) Pub. Date: Feb. 6, 2025

(54) METHOD FOR PROTECTING, BY LEVEL OF SENSITIVITY, PRIVACY OF PERSONAL LOCATION INFORMATION AND EFFICIENTLY RECOVERING SOURCE LOCATION

(71) Applicant: Korea Advanced Institute of Science and Technology, Daejeon (KR)

(72) Inventors: BrentByungHoon KANG, Daejeon (KR); Eunjin KIM, Daejeon (KR)

(73) Assignee: Korea Advanced Institute of Science and Technology, Daejeon (KR)

(21) Appl. No.: 18/919,004

(22) Filed: Oct. 17, 2024

(30) Foreign Application Priority Data
Apr. 22, 2022 (KR) 10-2022-0049978
Apr. 19, 2023 (WO) PCT/KR2023/005286

(51) Int. Cl. G06F 21/62; H04L 9/32

(52) U.S. Cl. CPC G06F 21/6245; H04L 9/3242

(57) ABSTRACT

A method for protecting the privacy of personal location information by level of sensitivity and efficiently recovering a source location is disclosed. The sensitive information protection and recovery method performed by means of a privacy control system, according to one embodiment, may comprise the steps of: processing privacy protection for sensitive information of a user, adjusted on the basis of privacy level selected according to a service by which the sensitive information was requested; and recovering the privacy-protected sensitive information of the user by using a secret key generated on the basis of the sensitive information of the user, adjusted on the basis of the privacy level.

### CROSS-REFERENCE TO RELATED APPLICATIONS

This application is a national stage entry of International Patent Application No. PCT/KR2023/005286, filed Apr. 19, 2023, which claims the benefit of priority of Korean Patent Application No. 10-2022-0049978, filed Apr. 22, 2022. Both of these applications are hereby incorporated by reference in their entirety.

### TECHNICAL FIELD

The following description relate to technology for privacy protection and recovery of sensitive information of a user.

### RELATED ART

An encryption technique, which is one of the conventional location privacy protection techniques, encrypts the entire location information to protect location information of a user from an untrustworthy service and allows users desiring to share their locations to restore their locations through key exchange between the users. This method has a limitation in that the method may not be applied to a model providing a service using a location since the service may not be aware of a location of a user.

To solve this issue, there is a spatial obfuscation technique that protects user privacy by adjusting accuracy of location information to a level required by a service. However, the spatial obfuscation technique applies a random or algorithmically determined value to location information as noise to make it impossible to identify an individual or a detailed location. To protect personal information while receiving a service using the personal information through the service, spatial obfuscation allows the use of sensitive information that is artificially reduced to minimum accuracy without interfering with service use.

User information, such as location information, requires accurate sensitive information to be used for purposes, such as forensics and internal audit, prevention of infectious diseases, and life-saving in the event of an accident. However, there is a disadvantage that sensitive information privacy-protected using existing research cannot be restored to original data.

### DETAILED DESCRIPTION

### Technical Subject

Example embodiments may provide a method and system that may fully recover and safely use privacy-protected sensitive information of a user when necessary.

Example embodiments may provide a method and system that may perform privacy protection processing and, at the same time, may restore original data related to privacy-protected sensitive information of a user to protect the sensitive information of the user.

### Solution

According to an aspect, there is provided a sensitive information protection and recovery method performed by a privacy control system, the sensitive information protection and recovery method including performing privacy protection processing for sensitive information of a user adjusted based on a privacy level that is selected according to a service that requests sensitive information; and recovering the privacy-protected sensitive information of the user using a secret key that is generated based on the sensitive information of the user adjusted based on the privacy level.

The performing of the privacy protection processing may include setting a privacy protocol registered to the service that requests the sensitive information and adjusting the privacy level for the sensitive information of the user using the set privacy protocol.

The performing of the privacy protection processing may include degrading accuracy of location information of the user by reducing the privacy level for the location information of the user when the sensitive information of the user is the location information of the user.

The performing of the privacy protection processing may include generating a secret key for the sensitive information of the user using confidential key generation information and public key generation information based on a key generation mechanism every time the privacy level for the sensitive information of the user is adjusted.

The secret key may be generated in a trusted execution environment (TEE).

The confidential key generation information may be stored in a safe storage to which access is impossible other than an authorized user, software module, or hardware module, and the public key generation information may be stored in a partial area that constitutes the location information as situational information including the service that requests random information or sensitive information.

The performing of the privacy protection processing may include generating a randomly generated salt and a master key stored in a safe storage as a single bitstream and generating an obfuscation key for the generated bitstream using a hash function.

Information used to generate the secret key in addition to the confidential key generation information stored in a safe storage may be stored in the error range of the sensitive information.

The sensitive information of the user may be location information of the user, and the performing of the privacy protection processing may include adjusting accuracy of the location information of the user using an encryption technique for the error range set to the location information of the user.

The performing of the privacy protection processing may include selecting the noise range set to the error range of the location information of the user at latitude and longitude expressed as an integer in a DMS or a decimal digital (DD) representation and performing encryption or an XOR operation with a key given to the error range of the location information of the user.

The sensitive information of the user may be location information of the user, and the recovering may include recovering the user's location information of which accuracy is adjusted using the error range of the location information of the user and a key given to the error range of the location information of the user.

The recovering may include restoring the location information of the user with the adjusted accuracy to accuracy of original location information at a preset privacy level for the location information of the user.

The recovering may include restoring the accuracy of the location information to accuracy lower than accuracy of original location information but higher than the adjusted accuracy through partial decryption within an encrypted area using an encryption technique for the error range of the location information of the user.

The recovering may include restoring location information including latitude and longitude through decryption or an XOR operation using the noise range set to the error range of the location information of the user and a key given to the error range of the location information of the user.

A privacy protocol or confidential key generation information stored in a safe storage may be stored using an asymmetric key or a symmetric key.

According to an aspect, there is provided a computer program stored in a non-transitory computer-readable recording medium to execute the sensitive information protection and recovery method on the privacy control system.

According to an aspect, there is provided a privacy control system including at least one processor configured to execute computer-readable instructions included in a memory, wherein the at least one processor is configured to perform privacy protection processing for sensitive information of a user adjusted based on a privacy level that is selected according to a service that requests sensitive information, and to recover the privacy-protected sensitive information of the user using a secret key that is generated based on the sensitive information of the user adjusted based on the privacy level.

### Effect

According to some example embodiments, to protect privacy of a user from a service that requests sensitive information such as location information of the user, it is possible to fully restore data without damage thereto for legal purpose, infectious disease prevention, and an accident safety structure when accurate data is required later, while controlling accuracy and sensitivity of sensitive information.

According to some example embodiments, it is expected that it may be set and used according to a security policy of each organization and institution or a service provider through restorable stepwise privacy protection processing technology.

According to some example embodiments, since privacy-protected sensitive information may be restored when necessary, it is possible to satisfy both privacy protection and data usability.

### BRIEF DESCRIPTION OF THE DRAWINGS

FIG. 1 illustrates a configuration of a privacy control system according to an example embodiment.

FIG. 2 illustrates an example of location information obfuscation within a range of about 100 m according to an example embodiment.

FIG. 3 is an example of location information obfuscation within a range of about 10 km according to an example embodiment.

FIG. 4 is an example of partially restoring accuracy of location information according to an example embodiment.

FIG. 5 illustrates an operation of generating a key that is difficult to infer according to an example embodiment.

FIG. 6 illustrates an example of describing an operation of storing location information of unprotected key generation information according to an example embodiment.

FIG. 7 illustrates an example of protecting accuracy of latitude data expressed in decimal digital (DD) representation and floating point according to an example embodiment.

FIG. 8 is a flowchart illustrating a method of protecting and recovering sensitive information in a privacy control system according to an example embodiment.

### BEST MODE

Hereinafter, example embodiments will be described with reference to the accompanying drawings.

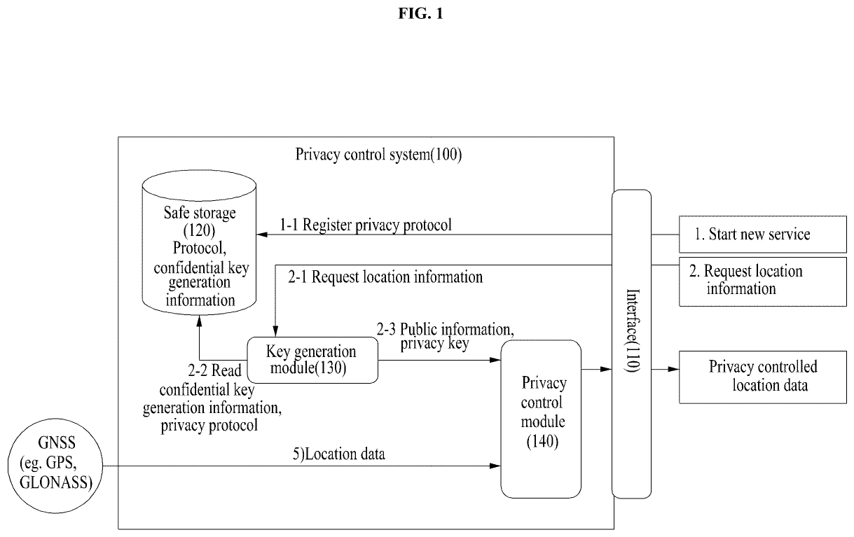

FIG. 1 illustrates a configuration of a privacy control system according to an example embodiment.

If sensitive information of a user is exposed, it may cause serious privacy violation. An example embodiment describes an operation of performing privacy protection processing by controlling a privacy level for sensitive information to protect privacy of the user from a service that requests the sensitive information of the user, and restoring privacy-protected sensitive information with damage to data when accurate data is required in the future. For example, for resilient privacy protection processing, accuracy and resolution of data may be lowered by inserting noise into a predefined specific area of data during a privacy protection processing process through partial encryption.

Sensitive information may be managed according to an information protection management system and regulation through a function of adjusting a privacy level of sensitive information by stage as well as privacy protection processing and restoration. Also, it is possible to provide protection of confidential information and privacy protocol used for privacy protection processing and privacy protection.

In an example embodiment, the sensitive information of the user relates to protecting privacy of the user and may represent identification information of the user (e.g., gender, age, address, phone number, e-mail address, resident registration number, etc.) and location information of the user. In addition, the sensitive information of the user may be present in various ways.

In an example embodiment, the privacy level represents increasing or decreasing sensitivity or accuracy for the sensitive information of the user. For example, the privacy level may relate to lowering a resolution of location information of the user.

As a method of adjusting the privacy level of the user's sensitive information, there may be provided a privacy protection method and system that satisfies privacy protection requirements by processing sensitive information and also allows the same to be used in the future for purposes, such as life saving and prevention of infectious disease. Also, described is an operation of reducing sensitive information inference attacks by adjusting the privacy level of the user's sensitive information of a plurality of stages for purposes and by recovering privacy-protected sensitive information of the user through adjustment.

When using a service that utilizes sensitive information (personal information) of a user, a privacy control system 100 may provide sensitive information of the user to select a lowest privacy level without disruption to service use. The privacy control system 100 may set various privacy protocols and may adjust sensitivity of the user's sensitive information using the set privacy protocols. For example, when the sensitive information of the user is location information, the privacy control system 100 may adjust accuracy. Here, if an attacker knows a privacy protocol (e.g., margin of error) applied to the location information of the user or confidential information that is required to adjust the privacy level, the privacy control system 100 may recover the accuracy of the user's location information without permission.

In an example embodiment, the location information of the user is described as an example of the sensitive information. Described is an operation of protecting confidential key generation information and privacy protocols in a safe storage to which only a specific module is accessible even within a system to prevent an attacker from accessing the confidential key generation information and the privacy protocols.

The privacy control system 100 may include an interface 110, a safe storage 120, a key generation module 130, and a privacy control module 140.

The interface 110 may transmit a request to the privacy control system 100 between a location system and another system or an application program and may output a response from the privacy control system 100. The interface 110 may transmit a request for privacy protocol information and location information to the privacy control system 100 and may output location information of which a privacy level is controlled to a location-based service that includes an application program.

The safe storage 120 may store data necessary for controlling privacy and privacy protocols, such as configuration values for a service that requests location information of the user, that is, the error range to be applied. For an attacker who is aware of a status of a sensitive information protection and recovery operation proposed herein, the range of accurate location estimation may be reduced by knowing the applied error range and the likelihood of successful attack may increase. Also, if confidential information among information used to generate an encryption key for each piece of location information is exposed, an attacker may acquire accurate location information without permission from the user. Therefore, privacy protocols and confidential key generation information need to be protected by being encrypted and stored in a memory or a storage device that only an authorized module may read or write. Data stored in the safe storage 120 is encrypted and stored and thus, may be read by only the key generation module 130 with an encryption key.

The key generation module 130 may generate an obfuscation key using a variety of other information along with the confidential key generation information and the privacy protocols stored in the safe storage 120. The key generation module 130 may read data by decrypting the data stored in the safe storage 120 using the encryption key. Information that needs to be stored, such as random information, may be delivered to the privacy control module 140 with the obfuscation key and may be stored as location information. The key generation module 130 may be executed within a trusted execution environment (TEE) and may safely generate the obfuscation key.

The privacy control module 140 may select the error range selected according to a service that requests location information and may adjust privacy sensitivity of the location information using the obfuscation key delivered from the key generation module 130. The privacy control module 140 may be executed within the TEE and may be safely executed without privacy leakage.

The privacy control system 100 may perform a privacy protection processing and recovery operation according to a sensitivity adjustment and recovery mechanism of the user's location information. The privacy control system 100 may perform privacy protection processing on sensitive information of the user by adjusting the privacy level of the user's location information that requires privacy protection and may restore the privacy-protected location information of the user later.

When specific information is known using a method, such as a secret key and stream encryption, the privacy control system 100 may recover accuracy of the user's location information. Technology capable of restoring previous information with awareness of specific information such as a secret key includes encryption and an XOR operation. Results generated by XOR and encryption technique may not be restored without the secret key and may not be readily distinguished from random data. Therefore, the technique, such as XOR or stream encryption, may achieve the similar effect as if random noise is added, by modifying data by applying privacy protection processing to the range (error range) representing an error required in location information of the user. Also, if the error range, an algorithm of generating noise, and the secret key are known from location information of the user with reduced accuracy, the original location information of the user may be recovered. The error range is defined as an area in which a privacy level of location information may be lowered to a level required according to a protocol and the degree of need, and may be expanded according to a decrease in the privacy level of location information. The algorithm of generating noise includes an encryption type and an operation mode. A type and a size of the secret key are determined according to an encryption type. A key used to adjust the privacy level is referred to as an obfuscation key.

### Example 1: Accuracy Adjustment of Location Information

An example of lowering accuracy of location information within the range of 10 m, 10 km is described. Initially, the privacy control system 100 may acquire location information through a global positioning system (GPS) and a global navigation satellite system (GLONASS) sensor. Here, it is assumed that accuracy of the acquired location information is about 1 m. The used location information is latitude 36° 22′13.09″ and longitude 127° 21′34.01″, which serves as a reference location.

Initially, the privacy control system 100 may express location information represented in DMS (representation method for representing location information in the National Marine Electronics Association (NMEA), standard used in a GPS sensor) using a decimal digit (DD) method. Here, when represented in DD, the location information becomes latitude 36.370302 and longitude 127.359447. To easily add noise to latitude and longitude values, the privacy control system 100 may express the location information represented in DD as an integer by removing a decimal point from the location information (latitude/longitude). In an example embodiment, an XOR method may be used to generate noise within the error range of location information. The privacy control system 100 may select the minimum bit range including the range of about 100 m, 10 km from latitude and longitude values expressed as integer and may perform an XOR operation on a key given to the error range.

TABLE 1
Error range of location information and applied key value

| | Accuracy | Latitude | | Longitude | |
|---|---|---|---|---|---|
| No. | adjustment range | noise range | | noise range | Key value |
| 1 | About 100 m | 0-9 | bit | 0-10 bit | 892 |
| 2 | About 10 km | 0-16 | bit | 0-16 bit | 60610 |
| 3 | About 10 km | 0-16 | bit | 0-16 bit | 20730 |

The privacy control system 100 may perform privacy processing by performing an XOR operation on a key given to the error range corresponding to 100 m in the location information. Case 1 in Table 1 shows the noise range and a key value used to adjust the accuracy in the error range of about 100 m. The error range to be applied when adjusting the accuracy in the range of about 100 m in the location information may be expressed as 9 bits at latitude 0 and as 10 bits at longitude 0.

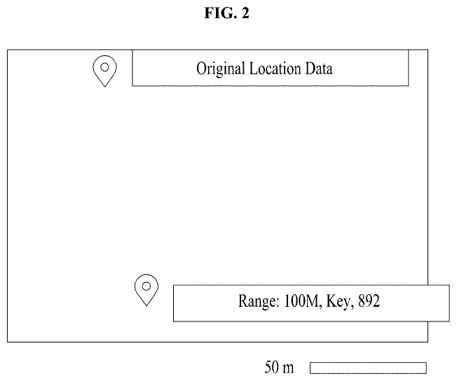

The XOR operation may be performed using the key given to the error range. The used key value is 892. Values calculated by adding noise to the location information are latitude 36.369,410 and longitude 127.359,659. FIG. 2 shows an example of location information obfuscation within the range of about 100 m. Referring to FIG. 2, location information and location information with adjusted accuracy are displayed on a map. A box area displayed in FIG. 2 refers to an area in which a location may vary when noise is applied to a value indicating the accuracy of about 100 m in the location information. It can be seen that location information with the reduced accuracy is present within the box area.

The privacy control system 100 may reduce the accuracy by performing an XOR operation on a key given to the error range corresponding to 10 km in the location information. Case 2 and Case 3 of Table 1 show the error range used to adjust the accuracy in the range of about 10 km and key values given to the error range. The error range to be applied when adjusting the accuracy in the range of about 10 km in the location information may be expressed as 16 bits at latitude 0 and as 16 bits at longitude 0.

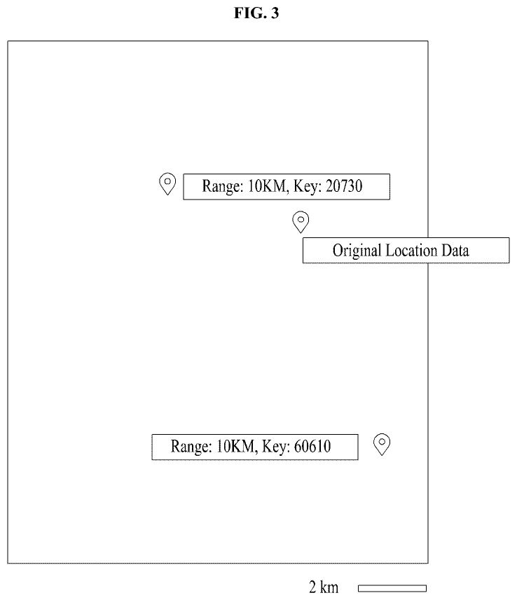

The privacy control system 100 performs the XOR operation using a 17-bit length key given to the error range. The used key values are 60610 in Case 2 and 20730 in Case 3. The values calculated by adding noise are latitude 36.379580 and longitude 127.317269 in Case 2 and latitude 36.349828 and longitude 127.338797 in Case 3. FIG. 3 shows an example of location information obfuscation within the range of about 10 km. Referring to FIG. 3, location information and two pieces of location information with the accuracy adjusted using two keys are displayed on a map. A box area displayed in FIG. 3 refers to an area in which a location may vary when noise is applied to a value indicating the accuracy of about 100 m in the location information. It can be seen that all of the two pieces of information with the adjusted accuracy are rearranged within the box area.

The privacy control system 100 may recover the user's location information of which accuracy is adjusted. To recover the user's location information with the adjusted accuracy, the privacy control system 100 may restore an area to which noise is added using an obfuscation key.

### Example 2: Recovery of Location Information with Adjusted Accuracy

The privacy control system 100 may recover the location information with the adjusted accuracy again using the secret key and the error range used in Example 1. The privacy control system 100 may restore each piece of location information calculated through Example 1 to original location information using the latitude/longitude error range and the secret key. Table 2 shows location information restored using the location information with the adjusted accuracy and the error range and the secret key used to adjust the accuracy. In Case 1, location information with the adjusted accuracy, longitude 36.369,412, latitude 127.359,659, is recovered using the given error range (latitude 9 bits, longitude 10 bits) and the secret key. Here, when the XOR operation is performed using the secret key 892 in the error range, latitude 36.379,302 and longitude 127.359,447 corresponding to original location information may be restored. Likewise, in Case 2 and Case 3, the original location information may be restored as a result of performing the XOR operation on the 16-bit error area at latitude and longitude using the secret key.

TABLE 2
Location obfuscation results and recovery results

| | | | Location | Location |
|---|---|---|---|---|
| | | | information | information |
| | | | (latitude/longitude) | (latitude/longitude) |
| Latitude/longitude | | Secret | with adjusted | with recovered |
| noise area | | key | accuracy | accuracy |
| 0-9 | bit/ | 892 | 36.369412/ | 36.370302/ |
| 0-10 | bit/ | | 127.359659 | 127.359447 |
| 0-16 | bit/ | 60610 | 36.314044/ | 36.370302/ |
| 0-16 | bit/ | | 127.382805 | 127.359447 |
| 0-16 | bit/ | 20730 | 36.379580/ | 36.370302/ |
| 0-16 | bit/ | | 127.317269 | 127.359447 |

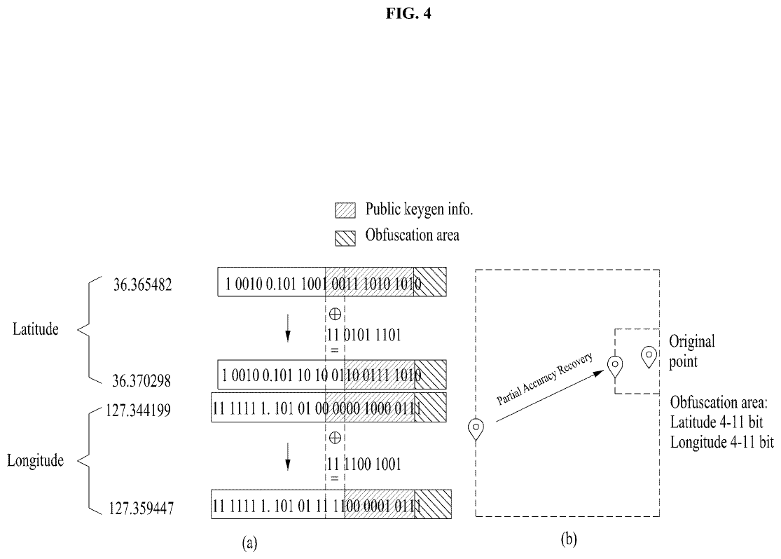

The privacy control system 100 may restore location information with adjusted accuracy to original accuracy at an initially set privacy level. Also, the privacy control system 100 may restore a desired portion in an encrypted area at an intermediate level of accuracy lower than accuracy of the original copy but higher than a current state through partial decryption. FIG. 4 shows an example of partially restoring accuracy of location information. FIG. 4 illustrates an example of partially improving accuracy of location information by selecting and storing only 0 to 11 bits rather than 0 to 13 bits, which is the error range applied to each latitude and longitude to lower the accuracy.

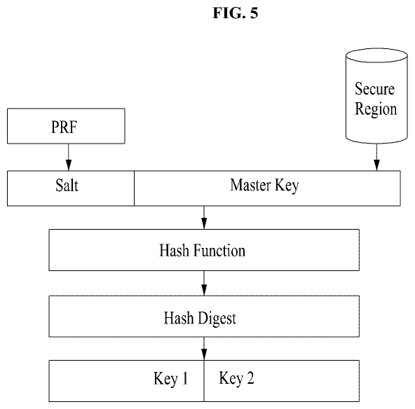

FIG. 5 illustrates an operation of generating a key that is difficult to infer according to an example embodiment.

A privacy control system may change a key used for privacy control every time, making it difficult to infer original location information and, at the same time, making it possible to restore an obfuscation key when recovering location information of a user.

In the case of adjusting a privacy level by recycling the same obfuscation key, it may be used for cryptographic attacks related to key reuse in stream ciphers, such as plaintext attacks and, as a result, original location information may be exposed. Also, when location information indicating the same location is repeatedly encrypted using the same obfuscation key, a movement pattern of the user is exposed to an attacker. Therefore, in all cases, a new key may need to be generated and used at all times when adjusting the privacy level.

When generating a secret key according to a key generation mechanism, the privacy control system may generate a new obfuscation key that is difficult to infer using confidential key generation information stored in a safe storage and public key generation information, such as a random value or situational information such as a service that requests location information. Also, the used public key generation information may be stored in a partial area that constitutes the location information. Later, the privacy control system may recover a key used for location obfuscation using the public key generation information.

The privacy control system may restore the obfuscation key used for location obfuscation to restore accuracy of each piece of location information. Here, confidential key generation information and public key generation information used to generate the obfuscation key may be used. Random is a powerful method for generating a key that is difficult to infer. However, due to its nature, a randomly generated value may not be recovered unless the value is stored. To store random information used to generate a new obfuscation key, the privacy control system may store the public key generation information in a portion of data that constitutes the location information. The confidential key generation information is stored in the safe storage and is accessible only to a user authorized by the system.

A key generation mechanism that is difficult to infer refers to a method of generating a key by including information stored in the safe storage to which an attacker is inaccessible. This information is referred to as confidential key generation information. The confidential key generation information, such as a master key stored in the safe storage, needs to be accessible only to an authorized user or hardware module. To restore an obfuscation key, a key is generated using confidential key generation information to which the attacker is inaccessible and thus, the attacker may not restore the obfuscation key. The combination of an algorithm (e.g., random, hash, encryption, one-time password (OTP), etc.) that generates the obfuscation key, confidential information, and public information may vary.

The key may be safely restored by storing key generation information in a portion of location information. The key generation mechanism that is difficult to infer may use a method of utilizing information, such as random salt, to generate a new key every location obfuscation. This information may be included in the aforementioned public key generation information. Unless this random information changes with each obfuscation attempt and is stored, the random information may not be restored for decryption and needs to be stored accordingly. To store public key generation information with this nature, the corresponding information may be stored in a portion of the location information.

### Example 3: Secure Obfuscation Key Generation Using Random Salt and Hash Function

FIG. 5 shows an example of generating an obfuscation key using a randomly generated salt and a master key stored in a secure region (e.g., safe storage) to which an attacker is inaccessible. The privacy control system may generate the random salt and the master key stored in the safe area as a single bitstream and may generate a new key for the generated bitstream using the hash function. The ideal hash function has a uniform distribution of result values, like random. Using this nature, a key similar to random and restorable may be generated.

Here, information used to generate the obfuscation key in addition to information stored in a safe location may be stored in a bit area representing a measurement error of positioning technology. Information used to generate location information needs to be stored in a place that does not degrade accuracy of information when restoring location information of which privacy protection is adjusted. To this end, effective location accuracy may be maintained by storing information used to generate the obfuscation key in a measurement error portion of each latitude and longitude of the location information.

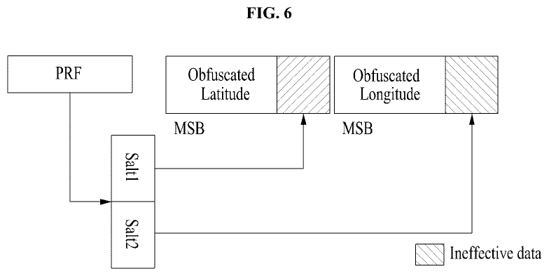

FIG. 6 shows an example of a method of storing a salt used in the key generation method in Example 3. The privacy control system may store a salt generated using a random function in an error range (area) that does not indicate effective accuracy of each latitude and longitude. Here, since a length of the salt is related to the number of generatable keys, a maximally long length of the salt needs to be stored. The privacy control system may secure a maximally large storage area by dividing and storing the salt in latitude and longitude data.

Referring again to FIG. 1, the privacy protection system 100 may store confidential key generation information required to generate an obfuscation key used for privacy control in a safe storage of a client rather than a location-based service and accordingly, may safely protect the confidential key generation information from the location-based service that attempts to inappropriately view location information of the user without consent from the user. Privacy protocols or confidential key generation information may be stored in the safe storage 120 using an asymmetric key or a symmetric key. When storing the privacy protocol in the safe storage before driving the system, the privacy protocol may be encrypted using the symmetric key maintained in the key generation module 130 and may be stored in the safe storage 120. In the case of adding the privacy protocol using the interface 110, the asymmetric key may be generated, the interface may add the privacy protocol using a public key, and the key generation module may decrypt the privacy protocol using the secret key. Likewise, the symmetric key or the asymmetric key may be selected depending on design of the system, and the confidential key generation information may be encrypted and then stored in the safe storage.

The privacy control system may set and manage a level of location information to be provided based on a service unit, and in response to a request for location information of the user from the service, may decrease accuracy of the location information by referring to a level of location information assigned to the service and then may restore the accuracy of the location information when a consent from the user (e.g., user authorized to access safe storage place of system) is received. Here, the privacy control system needs to meet the following.

First, the privacy control system may protect the safe storage using a TEE and may control access such that only a specific module may read and write in the safe storage. Second, a memory and an execution code of the privacy control module and the key generation module handling confidential information and the obfuscation key are protected through an environment of the TEE.

### Example 5: Key and Privacy Protocol Protection in Android System Using Security Extension Function (TrustZone)

Privacy protocols and confidential key generation information may be encrypted and stored in the safe storage using the symmetric key. When the system is initialized, the key generation module may decrypt the confidential key generation information using a secret key, and the privacy protocol and the confidential key generation information may be protected by being stored in Secure World while the system is running. When the system is terminated, the privacy protocol and the secret key are encrypted and stored again.

When the privacy control system receives a request for location information from a location-based service or an application program, the key generation module may generate an obfuscation key capable of retrieving the error range intentionally selected according to the privacy protocol stored in the safe storage and generating the corresponding error range. Here, the generated obfuscation key may be transmitted to the privacy control module to reduce accuracy of the location information and the location information with the reduced accuracy may be transmitted to the location-based service. Here, the key generation module and the privacy control module are executed in Secure World.

### Example 6: Location Information Request from Android App Running in ARM(Advanced RISC Machine) Environment that Supports Security Extension Function (TrustZone)

An operation of adjusting accuracy of GPS location information in Android app that supports TrustZone is described. In response to a request for GPS location information from Android app, the request may be transmitted to the system present in Secure World of TrustZone. The system may acquire location information from a GPS receiver (sensor). The error range to be applied to the location information may be determined using a privacy protocol registered to the system in advance before operating the system. The key generation module reads the error range to be applied from the privacy protocol and, based thereon, generates an obfuscation key with the same length as the error range. Location information read from a GPS may be encrypted using the obfuscation key in the privacy control module and then, a response may be transmitted to the app.

When the accuracy of location information needs to be recovered, the privacy control system may recover the accuracy of location information using the obfuscation key used to adjust the accuracy of location information. Recovery of the location information may infringe on the user's privacy and may be performed only when a restoration request is received from an authorized user.

The privacy control system may initially search the safe storage for a privacy protocol applied to data to be recovered, may identify an encrypted area from location information using the found privacy protocol, and then may decrypt the encrypted area using the obfuscation key. The recovered location information may be returned as a response to a target that requests restoration of location information accuracy.

### Example 7: Recovery of Location Information Stored in In-App Data in Android System Running in ARM Environment that Supports Security Extension Function (TrustZone)

An operation of recovering GPS location information of which a privacy level is adjusted in Android system that supports TrustZone is described. A user that desires to recover location information requests the system for restoration through the interface. The system may decrypt confidential key generation information stored in the safe storage by receiving locations of an app storing information to be recovered and location information, and a password of the user, or by going through a process of verifying that the user is a legitimate user. To recover the accuracy using the applied privacy protocol, confidential key generation information, and public key generation information, the system may restore an obfuscation key. Finally, the privacy control module may recover accuracy of location information to be recovered using the restored obfuscation key. The system records a response in a designated buffer and the interface reads the response recorded in the system and returns location information with the recovered accuracy as selected.

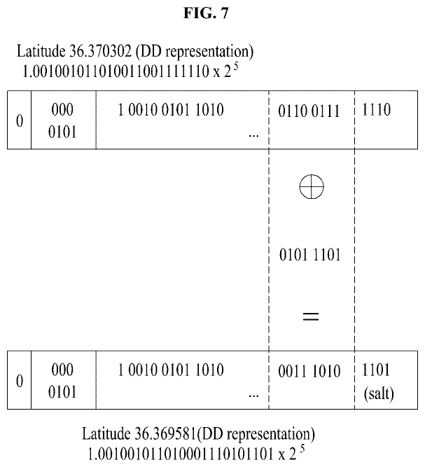

FIG. 7 illustrates an example of protecting accuracy of latitude data expressed in DD representation and floating point according to an example embodiment.

The privacy control system refers to a technique applicable regardless of whether a location-based service supports the corresponding technique and is highly practical since the privacy control system may protect a user's privacy without modifying an app and a server of the location-based service.

The privacy control system may be applied to decimal digit (DD, iso6709) that is a standard coordinate location representation, rather than a special location representation, and may be immediately applied to an application program that follows the standard.

By storing key generation information and the like in the measurement error range of positioning technology, an operation proposed in an example may be applied only with latitude and longitude of location information without a special data structure. FIG. 7 shows an example of reducing accuracy of location information using an operation proposed in an example embodiment for latitude expressed with the DD representation. The DD representation and an operation of reducing accuracy of longitude and recovering the accuracy when the DD representation is expressed as a standard floating-point representation (IEEE 754) may be applied in the same manner.

Also, when the privacy protection system is applied to a terminal of the user, location information with the reduced accuracy is transmitted to the location-based service and thus, there is no essential function that the location-based service needs to support. Accordingly, even a potentially dangerous location-based service may protect the privacy.

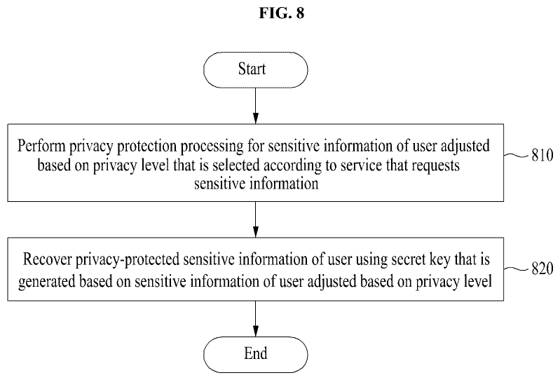

FIG. 8 is a flowchart illustrating a method of protecting and recovering sensitive information in a privacy control system according to an example embodiment.

In operation 810, the privacy control system may perform privacy protection processing for sensitive information of a user adjusted based on a privacy level that is selected according to a service that requests sensitive information. The privacy control system may set a privacy protocol registered to the service that requests the sensitive information and may adjust the privacy level for the sensitive information of the user using the set privacy protocol. When the sensitive information of the user is location information of the user, the privacy control system may degrade accuracy of the location information of the user by reducing the privacy level for the location information of the user.

Every time the privacy level for the sensitive information of the user is adjusted, the privacy control system may generate a secret key for the sensitive information of the user using confidential key generation information and public key generation information based on a key generation mechanism. The privacy control system may generate a randomly generated salt and a master key stored in a safe storage as a single bitstream and may generate an obfuscation key for the generated bitstream using a hash function. The privacy control system may adjust accuracy of the location information of the user using an encryption technique for the error range set to the location information of the user. The privacy control system may select the noise range set to the error range of the location information of the user at latitude and longitude expressed as an integer in DMS or DD representation and may perform encryption or an XOR operation with a key given to the error range of the location information of the user.

In operation 820, the privacy control system may recover the privacy-protected sensitive information of the user using a secret key that is generated based on the sensitive information of the user adjusted based on the privacy level. The privacy control system may recover the user's location information of which accuracy is adjusted using the error range of the location information of the user and a key given to the error range of the location information of the user. The privacy control system may recover the location information of the user with the adjusted accuracy to accuracy of original location information at a preset privacy level for the location information of the user. The privacy control system may restore the accuracy of the location information to accuracy lower than the accuracy of the original location information but higher than the adjusted accuracy through partial decryption within an encrypted area using an encryption technique for the error range of the location information of the user. The privacy control system may restore location information including a location and longitude through decryption or an XOR operation using the noise range set to the error range of the location information of the user and a key given to the error range of the location information of the user.

### Mode

The apparatuses described herein may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to example embodiments may be implemented in a form of a program instruction executable through various computer methods and recorded in non-transitory computer-readable media. The media may include, alone or in combination with program instructions, a data file, a data structure, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of program instructions include a machine code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A sensitive information protection and recovery method performed by a privacy control system, the sensitive information protection and recovery method comprising:
performing privacy protection processing for sensitive information of a user adjusted based on a privacy level that is selected according to a service that requests sensitive information; and
recovering the privacy-protected sensitive information of the user using a secret key that is generated based on the sensitive information of the user adjusted based on the privacy level.

2. The sensitive information protection and recovery method of claim 1, wherein the performing of the privacy protection processing comprises setting a privacy protocol registered to the service that requests the sensitive information and adjusting the privacy level for the sensitive information of the user using the set privacy protocol.

3. The sensitive information protection and recovery method of claim 2, wherein the performing of the privacy protection processing comprises degrading accuracy of location information of the user by reducing the privacy level for the location information of the user when the sensitive information of the user is the location information of the user.

4. The sensitive information protection and recovery method of claim 1, wherein the performing of the privacy protection processing comprises generating a secret key for the sensitive information of the user using confidential key generation information and public key generation information based on a key generation mechanism every time the privacy level for the sensitive information of the user is adjusted.

5. The sensitive information protection and recovery method of claim 4, wherein the secret key is generated in a trusted execution environment (TEE).

6. The sensitive information protection and recovery method of claim 4, wherein the confidential key generation information is stored in a safe storage to which access is impossible other than an authorized user, software module, or hardware module, and
the public key generation information is stored in a partial area that constitutes the location information as situational information including the service that requests random information or sensitive information.

7. The sensitive information protection and recovery method of claim 4, wherein the performing of the privacy protection processing comprises generating a randomly generated salt and a master key stored in a safe storage as a single bitstream and generating an obfuscation key for the generated bitstream using a hash function.

8. The sensitive information protection and recovery method of claim 4, wherein information used to generate the secret key in addition to the confidential key generation information stored in a safe storage is stored in the error range of the sensitive information.

9. The sensitive information protection and recovery method of claim 1, wherein the sensitive information of the user is location information of the user, and
the performing of the privacy protection processing comprises adjusting accuracy of the location information of the user using an encryption technique for the error range set to the location information of the user.

10. The sensitive information protection and recovery method of claim 9, wherein the performing of the privacy protection processing comprises selecting the noise range set to the error range of the location information of the user at latitude and longitude expressed as an integer in a DMS or a decimal digital (DD) representation and performing encryption or an XOR operation with a key given to the error range of the location information of the user.

11. The sensitive information protection and recovery method of claim 1, wherein the sensitive information of the user is location information of the user, and
the recovering comprises recovering the user's location information of which accuracy is adjusted using the error range of the location information of the user and a key given to the error range of the location information of the user.

12. The sensitive information protection and recovery method of claim 11, wherein the recovering comprises restoring the location information of the user with the adjusted accuracy to accuracy of original location information at a preset privacy level for the location information of the user.

13. The sensitive information protection and recovery method of claim 11, wherein the recovering comprises restoring the accuracy of the location information to accuracy lower than accuracy of original location information but higher than the adjusted accuracy through partial decryption within an encrypted area using an encryption technique for the error range of the location information of the user.

14. The sensitive information protection and recovery method of claim 11, wherein the recovering comprises restoring location information including latitude and longitude through decryption or an XOR operation using the noise range set to the error range of the location information of the user and a key given to the error range of the location information of the user.

15. The sensitive information protection and recovery method of claim 1, wherein a privacy protocol or confidential key generation information stored in a safe storage is stored using an asymmetric key or a symmetric key.

16. A privacy control system comprising:
at least one processor configured to execute computer-readable instructions included in a memory,
wherein the at least one processor is configured to
perform privacy protection processing for sensitive information of a user adjusted based on a privacy level that is selected according to a service that requests sensitive information, and
recover the privacy-protected sensitive information of the user using a secret key that is generated based on the sensitive information of the user adjusted based on the privacy level.
